(19) United States
(12) Patent Application Publication
(10) Pub. No.: US 2013/0132896 A1
(43) Pub. Date: May 23, 2013

(54) SYSTEM AND METHOD OF RECOMMENDING APPLICATIONS BASED ON CONTEXT INFORMATION

(71) Applicants: Seung-soo LEE, Seoul (KR); Man-seok KANG, Yongin-si (KR); Sei-kwon KIM, Yongin-si (KR)

(72) Inventors: Seung-soo LEE, Seoul (KR); Man-seok KANG, Yongin-si (KR); Sei-kwon KIM, Yongin-si (KR)

(73) Assignee: SAMSUNG ELECTRONICS CO., LTD., Suwon-si (KR)

(21) Appl. No.: 13/554,015

(22) Filed: Jul. 20, 2012

(30) Foreign Application Priority Data
Nov. 22, 2011 (KR) 10-2011-0122396

(51) Int. Cl. G06F 3/048

(52) U.S. Cl. 715/808; 715/846

(57) ABSTRACT

A method and apparatus for recommending and displaying a recommended application, in terms of context, from among a plurality of applications in an apparatus are provided. The method includes: collecting context information of a user; determining at least one recommended application from among applications included in the apparatus based on the collected context information; and displaying the at least one recommended application based on the determination.

### CROSS-REFERENCE TO RELATED PATENT APPLICATION

This application claims priority from Korean Patent application No. 10-2011-0122396, filed on Nov. 22, 2011, in the Korean Intellectual Property Office, the disclosure of which is incorporated herein by reference in its entirety.

### BACKGROUND

1. Field

Systems and methods relate to a system and method of recommending applications based on context information, and more particularly, to a method and apparatus allowing a user to easily find applications suitable in terms of context from among a plurality of applications in the apparatus.

2. Description of the Related Art

Recently, users have access to at least thousands, up to millions of applications (hereinafter, referred to as ‘apps’) (games, news, stock markets, social network services (SNSs), etc.) through various types of terminals (televisions, smart phones, personal computers (PCs), etc.), and the users may install desired apps in their terminals. The installed apps are arranged as icons in a menu list or on a home screen, and each icon has a predetermined size (about 72×72 pixels in the case of a smartphone). When the number of apps installed in the terminal by the user increases, it may be inconvenient for the user to access the app that he or she wishes to use.

In particular, in the case of terminals having small screens such as smart phones and MP3 players, except for PCs, inconvenience when using the apps is further increased. Since a portable terminal has a restricted area (display size) for displaying the installed apps, the user has to move through screens or complex menu depths on a user interface (UI) in order to find the icon of the app to be used from among the plurality of app icons. Accordingly, methods of easily accessing an app, which the user wishes to use at a certain point of time, from among the installed apps have been suggested.

However, according to the conventional art, menu or apps are re-arranged based on usage information of the user; that is, a frequently used app or long-time used app, and thus app recommendation suitable for various circumstances of the user may not be provided. In addition, even when an app that is suitable for the user under a certain circumstance is installed in the portable terminal of the user, if the user does not appreciate functions or features of the corresponding app and has not frequently used the app recently, the corresponding app may not be determined as a recommended app. The above problem becomes severe when the number of apps installed in the portable terminal of the user increases, because the user may not appreciate the functions of all the installed apps. Moreover, if apps that are frequently used by other users in certain circumstances are already installed in the terminal of the user but the user does not frequently use them, these apps may not be determined as the recommended apps. In a manner of accessing the recommended apps, an entire arrangement of the menu or icons are changed often based on the recommended apps, thereby causing confusion for the user rather than increasing user convenience.

### SUMMARY

Exemplary embodiments provide a method and apparatus for recommending applications suitable for a user of a portable terminal by using context information of the user and context information of other users.

Exemplary embodiments also provide a method and apparatus for using recommended applications by easily and intuitively accessing the recommended applications for users of a portable terminal.

According to an exemplary embodiment, there is provided an apparatus for recommending applications based on context information, the apparatus including: a context information collecting unit which collects context information; a recommended application determination unit which determines at least one recommended application from among applications based on the collected context information; a display setting unit which sets an icon of the at least one recommended application to be displayed based on the determination of the recommended application determination unit; and a display unit which displays the icon of the at least one recommended application based on settings of the display setting unit. The applications may be included in the apparatus. The context information may be related to a user.

The context information may include at least one from among location information and time information of the apparatus.

The recommended application determination unit may determine the at least one recommended application from among applications executed more frequently than a predetermined frequency and applications executed longer than a predetermined time period, in the applications of the apparatus.

The recommended application determination unit may determine at least one from among an application having a type corresponding to applications executed more frequently than a predetermined frequency and an application having a type corresponding to applications executed longer than a predetermined time period, in the applications of the apparatus.

The context information collecting unit may include a receipt unit for receiving information related to an application recommendation from a server or at least one other apparatus, and the recommended application determination unit may determine the recommended application based on the collected context information and the received information related to the application recommendation.

The received information related to the application recommendation may include at least one from among names, types, and featured functions of applications that are used in the at least one other apparatus.

The recommended application determination unit may determine at least one from among an application that is the same as the application included in the information related to the application recommendation and an application having a type corresponding to the application included in the information related to the application recommendation, from among the applications in the apparatus.

The at least one other apparatus may be located within a predetermined distance from the apparatus.

The display setting unit may perform display setting so that icons of the applications included in the apparatus are displayed as in a previous arrangement, and at least one icon of a recommended folder may match with the at least one recommended application or an icon of the at least one recommended application.

The display setting unit may designate a part of the display unit as a recommendation display area, and may display the at least one icon of the recommended folder and the recommended application in the recommendation display area.

The display setting unit may set the recommendation display area to be displayed in a partitioned region that is set in the display unit in advance.

The display setting unit may set the recommendation display area to be displayed as a pop-up window on the display unit.

The display setting unit may set an icon of the at least one recommended application matching with the recommended folder icon to be further displayed when the recommended folder icon is selected by an input of a user.

The display setting unit may set the icon of the at least one recommended application to have a different size from icons of other applications in the apparatus.

The display setting unit may set the icon of the recommended application to repeatedly flicker or rotate.

The display setting unit may set a color of the icon of the at least one recommended application to be distinguished from a color of the icon of an application that is not recommended, by changing a color of at least a part of the display unit, or changing a color of at least one from among icons of the applications in the apparatus and the icon of the at least a recommended application.

According to another exemplary embodiment, there is provided a server which provides an apparatus with information related to an application recommendation, the server including: a receipt unit which receives information about applications used in other apparatuses, from the other apparatuses; a recommended information determination unit which determines the information related to the application recommendation, which is to be transmitted to the apparatus, based on the received information; and a transfer unit which transmits the information related to the application recommendation determined by the recommended information determination unit, wherein the information related to the application recommendation is used to determine an application to be recommended from among applications. The applications may be included in the apparatus.

The received information may include information about at least one of names, types, featured functions, usage frequencies, and usage times of the applications used in the other apparatuses.

The recommended information determination unit may determine at least one from among applications used in a predetermined number or more of other apparatuses, applications that are used more frequently than a predetermined frequency, and applications that are used longer than a predetermined time period, as a recommended application, and the information related to the application recommendation may include information about at least one from among a name, a type, and featured functions of the recommended application.

The other apparatuses may be located within a predetermined distance from the apparatus.

According to another exemplary embodiment, there is provided a method of recommending and displaying an application in an apparatus, the method including: collecting context information; determining at least one recommended application from among applications included in the apparatus based on the collected context information; and displaying the at least one recommended application based on the determination. The context information may be related to a user.

According to another exemplary embodiment, there is provided a method of providing an apparatus with information related to an application recommendation from a server, the method including: receiving information about applications used in other apparatuses from the other apparatuses; determining information related to the application recommendation, which is to be transferred to the apparatus; and transferring, by the server, the determined information related to the application recommendation to the apparatus from the server, wherein the transferred information related to the application recommendation is used to determine an application to be recommended from among applications. The receiving and the determining may be performed by the server. The applications may be included in the apparatus.

According to another exemplary embodiment, there is provided a computer readable recording medium having embodied thereon a program for executing a method of recommending and displaying an application in an apparatus, wherein the method may include: collecting context information of a user; determining at least one recommended application from among applications included in the apparatus based on the collected context information; and displaying the at least one recommended application based on the determination.

According to another exemplary embodiment, there is provided a computer readable recording medium having embodied thereon a program for executing a method of providing an apparatus with information related to an application recommendation from a server, wherein the method may include: receiving information about applications used in other apparatuses from the other apparatuses; determining information related to the application recommendation, which is to be transferred to the apparatus; and transferring, by the server, the determined information related to the application recommendation to the apparatus from the server, wherein the transferred information related to the application recommendation is used to determine an application to be recommended from among the applications. The receiving and the determining may be performed by the server. The applications may be included in the apparatus.

### BRIEF DESCRIPTION OF THE DRAWINGS

The above and other features will become more apparent by describing in detail exemplary embodiments with reference to the attached drawings in which:

FIG. 1 is a block diagram of an application (app) recommendation system based on context information according to an exemplary embodiment;

FIG. 2 is a schematic block diagram of a terminal according to an exemplary embodiment;

FIG. 3 is a block diagram showing a context information collecting unit in the terminal of FIG. 2 in detail;

FIG. 4 is a schematic block diagram of a server according to an exemplary embodiment;

FIG. 5 is a schematic block diagram of a system of transmitting/receiving app related information between the terminal according to an exemplary embodiment and other terminals located within a predetermined distance from the terminal;

FIG. 6 is a flowchart illustrating processes of storing context information and information related to an executed app when the app is executed in the terminal according to an exemplary embodiment;

FIGS. 7A through 7C are flowcharts illustrating processes of determining and displaying a recommended app in the terminal according to exemplary embodiments; and

FIGS. 8A through 8D are diagrams showing examples of a screen displaying a recommended app according to exemplary embodiments.

### DETAILED DESCRIPTION OF EXEMPLARY EMBODIMENTS

Exemplary embodiments will now be described more fully with reference to the accompanying drawings, in which exemplary embodiments are shown. Exemplary embodiments may, however, be embodied in many different forms and should not be construed as being limited to the exemplary embodiments set forth herein; rather, these exemplary embodiments are provided so that this disclosure will be thorough and complete, and will fully convey the inventive concept to those of ordinary skill in the art. In the drawings, the thicknesses of layers and regions are exaggerated for clarity. Like reference numerals in the drawings denote like elements, and thus their description will be omitted. Expressions such as “at least one of,” when preceding a list of elements, modify the entire list of elements and do not modify the individual elements of the list.

Hereinafter, exemplary embodiments will be described with reference to accompanying drawings.

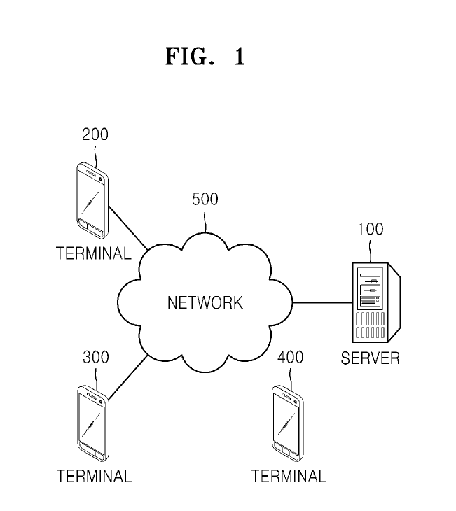

FIG. 1 is a block diagram showing an entire application (app) recommendation system based on context information according to an exemplary embodiment.

As shown in FIG. 1, the app recommendation system includes a server 100 and a plurality of apparatuses 200, 300, and 400, and the server 100 and the plurality of apparatuses 200, 300, and 400 communicate with each other through a network 500. The apparatuses 200, 300, and 400 may be portable terminals (for example, smart phones, portable media players (PMPs), etc.) that may be used by a user while moving; however, they may also be fixed apparatuses (for example, personal computers (PCs), internet protocol televisions (IPTVs), etc.) used by a user in a fixed location. The apparatuses 200, 300, and 400 may include a plurality of apps. Hereinafter, the apparatuses 200, 300, and 400 will be referred to as portable terminals for convenience of description.

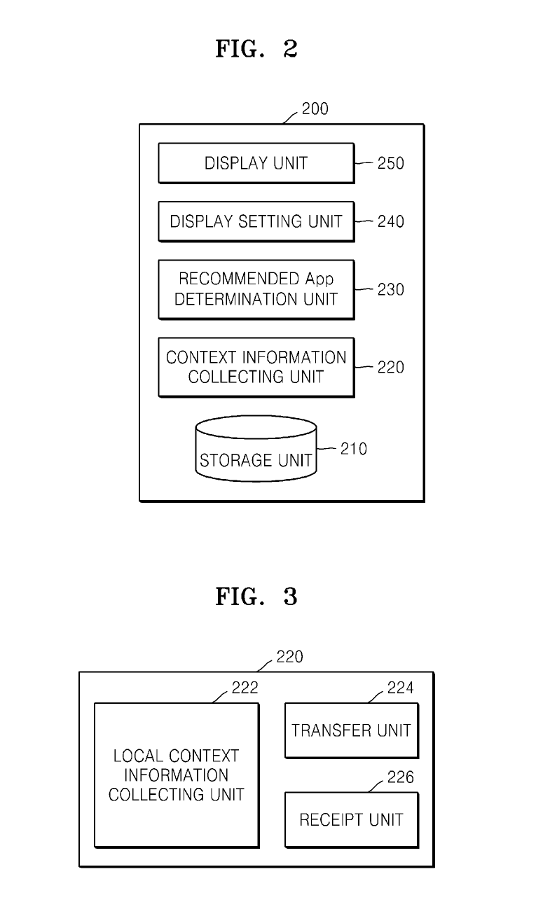

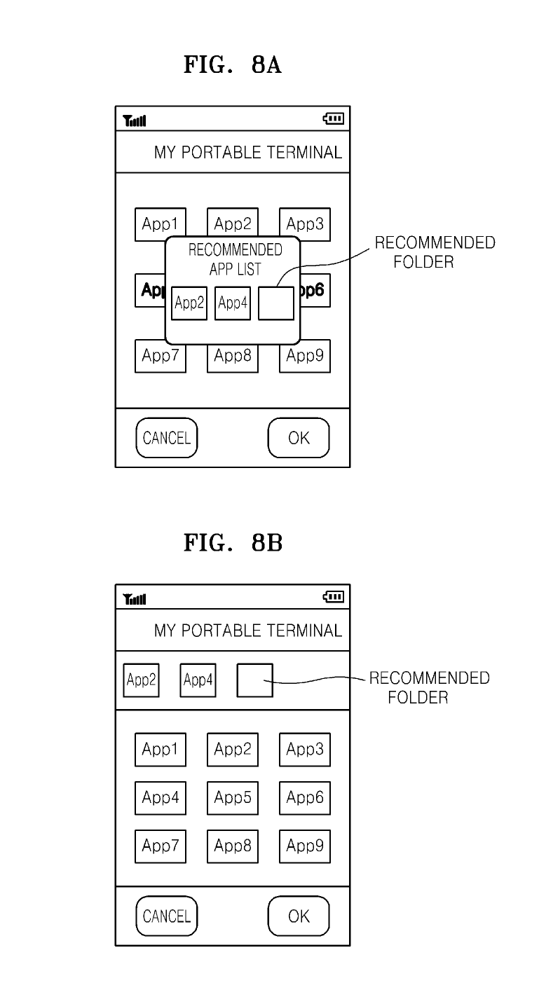

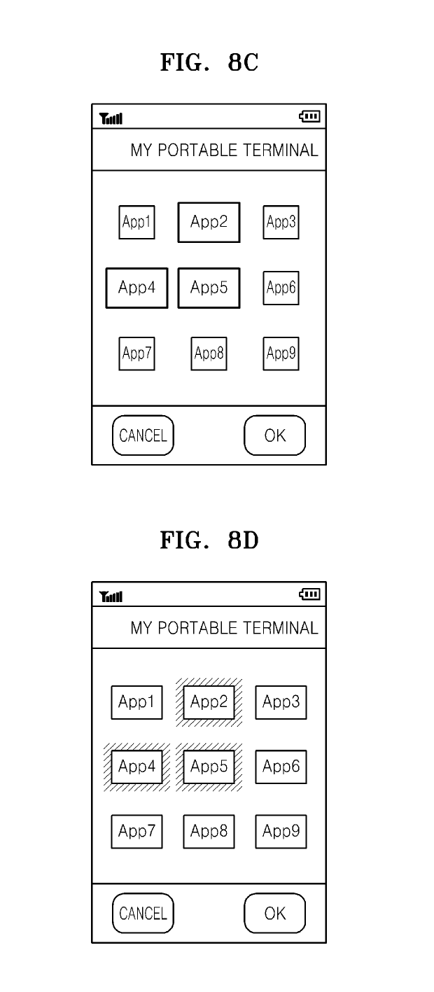

When a user requests an app recommendation, the portable terminal 200 determines a recommended app from among the apps in the portable terminal 200 and displays the determined recommended app to the user. The portable terminal 200 may determine the recommended app by using context information of the user of the portable terminal 200 and using information received from the server 100 or the other portable terminals 300 and 400 through the network 500. Processes of determining and displaying the recommended app will be described in more detail with reference to FIG. 2 and FIGS. 8A through 8D.

FIG. 2 is a schematic block diagram of the portable terminal 200 for recommending the app to the user based on the context information according to an exemplary embodiment.

As shown in FIG. 2, the portable terminal 200 includes a storage unit 210, a context information collecting unit 220, a recommended app determination unit 230, a display setting unit 240, and a display unit 250.

The storage unit 210 stores information required to operate the portable terminal 200 (for example, a version of an operating system (O/S), or an address book), and the context information collected by the context information collecting unit 220 as will be described later. In addition, the storage unit 210 also stores information about the apps in the portable terminal 200 (for example, names, types, principal functions, generation times, and latest update dates of the apps).

The context information collecting unit 220 collects various context information related to usage of the portable terminal 200 by the user. The context information may include information about a time when the execution of the app in the portable terminal 200 starts and ends, physical location information of the portable terminal 200, and weather information (for example, temperature or humidity) of the region where the portable terminal 200 is used. The context information collecting unit 200 collects the context information and stores the collected information in the storage unit 210.

According to an exemplary embodiment, the context information collecting unit 220 may receive information about an app recommendation from the server 100 or the other terminals 300 and 400 through the network 500 of FIG. 1. The information about the app recommendation is used by the portable terminal 200 to determine the recommended app, and is received from the server 100 or the other terminals 300 and 400. The information about the app recommendation may include at least one of names, types, featured functions, generation times, latest update dates, times of usage, locations, and execution frequencies of apps used in the other terminals 300 and 400. The context information collecting unit 220 stores the information about the app recommendation in the storage unit 210. A detailed structure of the context information collecting unit 220 will be described with reference to FIG. 3.

The recommended app determination unit 230 determines an app to be recommended when a signal requesting the app recommendation is input in the portable terminal 200. The signal requesting the app recommendation may be input by the user of the portable terminal 200, or may be input from the other terminals 300 and 400 or the server 100 through the network 500 of FIG. 1. In some exemplary embodiments, an operation of determining the app to be recommended may be automatically performed without any input signal from outside of the portable terminal 200, or may be automatically performed after a certain event occurs in the portable terminal 200.

The recommended app determination unit 230 determines the app to be recommended from among the apps included in the portable terminal 200, based on the context information stored in the storage unit 210.

According to an exemplary embodiment, the recommended app determination unit 230 may determine an app that is more frequently used than a predetermined frequency by the user or an app that is used longer than a predetermined time as the recommended app in consideration of a location where the determination of the recommended app is performed (that is, the location of the portable terminal 200) and the time when the determination is performed.

In another exemplary embodiment, the recommended app determination unit 230 may determine an app of a type corresponding to an app that is more frequently used than a predetermined frequency by the user or an app that is used longer than a predetermined time as a recommended app, in consideration of a location where the determination of the recommended app is performed (that is, the location of the portable terminal 200), the time when the determination is performed, and information about the apps stored in the storage unit 210. The recommended app determination unit 230 may determine the apps that correspond to each other by determining that at least one of the names, types, and featured functions of the apps are the same as each other.

In another exemplary embodiment, the recommended app determination unit 230 may determine an app, the latest update of which is applied, from among a plurality of apps of the type corresponding to the app that is more frequently used than a predetermined frequency by the user or an app that is used longer than a predetermined time, as the recommended app, in consideration of a location where the determination of the recommended app is performed (that is, the location of the portable terminal 200), the time when the determination is performed, and information about the apps stored in the storage unit 210.

The display setting unit 240 determines a way of displaying an icon of the recommended app determined by the recommended app determination unit 230 with icons of the apps displayed on the display unit 250 (hereinafter, referred to as existing apps), on the display unit 250, before displaying the recommended app on the display unit 250. Processes of displaying the existing apps and the recommended app by the display setting unit 240 will be described in detail with reference to FIGS. 8A through 8D.

FIG. 3 is a block diagram showing a detailed structure of the context information collecting unit 220 in the portable terminal 200.

According to the present exemplary embodiment, the context information collecting unit 220 includes a local context information collecting unit 222, a transfer unit 224, and a receipt unit 226.

The local context information collecting unit 222 receives context information that may be collectable by the portable terminal 200 itself, rather than the information received from the outside through the network, and stores the collected information in the storage unit 210. For example, the context information collected by the local context information collecting unit 222 may include information about a time when the execution of the app starts and ends, physical location information of the portable terminal 200, and weather information of the region where the portable terminal 200 is used (for example, temperature and humidity).

The receipt unit 226 receives a signal or information from outside, that is, the server 100 or the other portable terminals 300 and 400. For example, the receipt unit 226 may receive information about a certain app in the portable terminal 200 from the server 100. In addition, the receipt unit 226 may receive information related to the app recommendation from the server 100 or the other portable terminals 300 and 400 through the network 500 of FIG. 1. The information received by the receipt unit 226 is stored in the storage unit 210.

In addition, the receipt unit 226 may receive a request to transmit the information related to the app recommendation from the other terminals 300 and 400. In this case, the transfer unit 224 transfers the information related to the app recommendation to the other terminals 300 and 400 through the network 500. This will be described in more detail in the description about the transfer unit 224.

The transfer unit 224 transfers a signal or information to the outside, that is, the server 100 or the other portable terminals 300 and 400. For example, when the portable terminal 200 collects the context information, if the local context information collecting unit 222 determines that the information about the currently executed app (for example, name, type, featured functions, generation time, and the latest update date) is not stored in the storage unit 210, the transfer unit 224 may request the server 100 to transmit the information about the currently executed app through the network 500.

In addition, the transfer unit 224 may transmit a request signal for requesting the information related to the app recommendation to the server 100 or the other portable terminals 300 and 400. When a request to transmit the information related to the app recommendation is received from the server 100 or the other portable terminals 300 and 400, the transfer unit 224 may transmit the information related to the app recommendation to the server 100 or the portable terminals 300 and 400 in response to the request. The information related to the app recommendation transferred by the transfer unit 224 may include information about the app that is currently executed in the current portable terminal 200, the app that is more frequently used than a predetermined frequency, or the app that is used longer than a predetermined time period at a point of time and location where the request to transmit the information related to the app recommendation is received. In addition, the information about the app transmitted by the transfer unit 224 may include the name, type, featured functions, generation time, and the latest update date of the app.

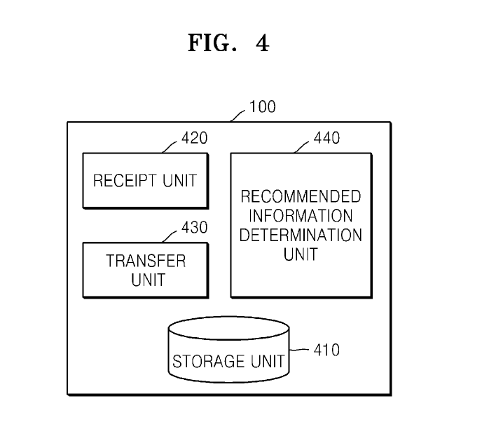

FIG. 4 is a schematic block diagram of the server 100 according to an exemplary embodiment.

The server 100 includes a storage unit 410, a receipt unit 420, a transfer unit 430, and a recommended information determination unit 440.

The storage unit 410 stores information about the app (for example, the name, type, featured functions, generation time, and the latest update date of the app), or information related to the app recommendation.

The receipt unit 420 receives a request to transmit the information about the app or a request to transmit the information related to the app recommendation from the portable terminal 200. In addition, the receipt unit 420 may receive information related to the app recommendation from the other portable terminals 300 and 400.

When the receipt unit 420 receives the request to transmit the information about the app from the portable terminal 200, the transfer unit 430 reads the information about the corresponding app from the storage unit 410 and transfers the information to the portable terminal 200. According to the present exemplary embodiment, the transfer unit 430 transmits a request to transmit the information related to the app recommendation to the other portable terminals 300 and 400. In addition, the transfer unit 430 may transmit the information related to the app recommendation determined by the recommended information determination unit 440 to the portable terminal 200 that requests the corresponding information.

The recommended information determination unit 440 determines final information related to the app recommendation based on the information related to the app recommendation received from the other portable terminals 300 and 400, and transmits the determined information to the portable terminal 200 that requests the information related to the app recommendation. According to the exemplary embodiment, the final information related to the app recommendation may include information about the app that is used in the largest number of portable terminals, the app that is used more frequently than a predetermined frequency, or the app that is used longer than a predetermined time period. In addition, the final information related to the app recommendation may include information about at least one of the name, type, and the featured functions of the app.

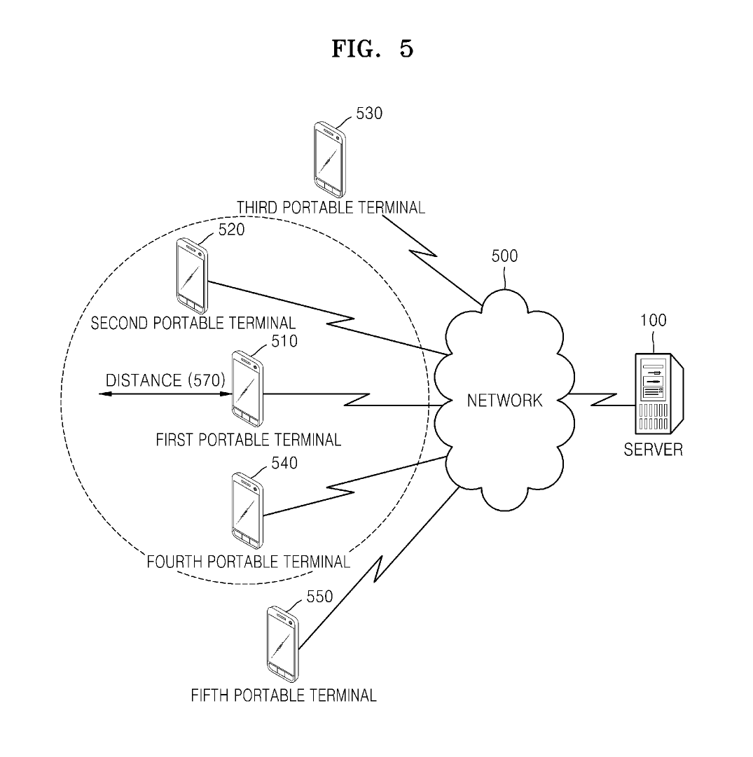

FIG. 5 is a diagram showing a system in which a first portable terminal 510 transmits/receives information related to the app recommendation to/from other portable terminals 520 through 550 via a server 100, according to an exemplary embodiment.

In FIG. 5, the first portable terminal 510 requests the server 100 of the information related to the app recommendation through a network 500. The server 100 receives the request to transmit the information related to the app recommendation from the first portable terminal 510, and identifies a location of the first portable terminal 510. Next, the server 100 identifies other portable terminals located within a predetermined distance from the first portable terminal 510 from among the portable terminals 520 through 550 communicating with the server 100 via the network 500; that is, the second portable terminal 520 and the fourth portable terminal 540. Then, the server 100 requests the second and fourth portable terminals 520 and 540 for information related to the app recommendation. The server 100 receives the information related to the app recommendation from the second and fourth portable terminals 520 and 540, determines final information related to the app recommendation, and transmits the determined information to the first portable terminal 510. The information related to the app recommendation received by the server 100 may include information about at least one of names, types, and featured functions of the apps that are used in the second and fourth portable terminals 520 and 540 more frequently than a predetermined frequency and the apps that are used longer than a predetermined time period in the second and fourth portable terminals 520 and 540.

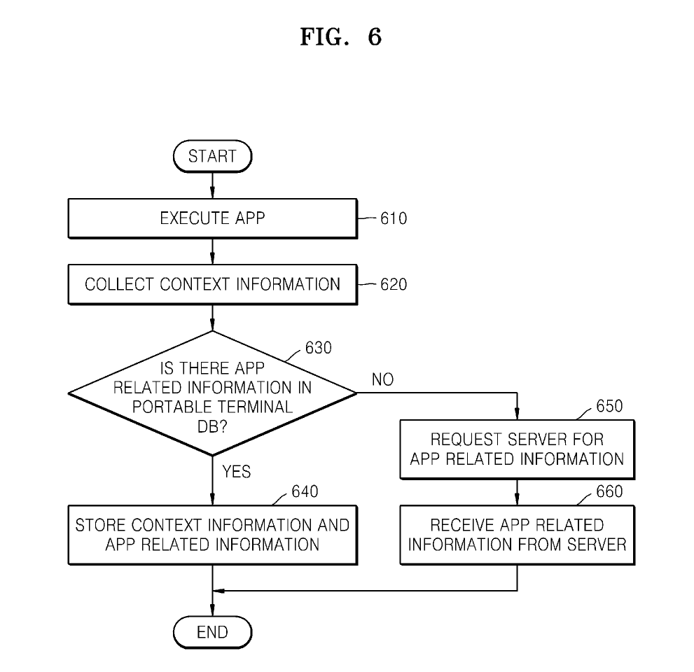

FIG. 6 is a flowchart illustrating processes of storing the context information and the information about the executed app when an app is executed in the portable terminal 200 according to an exemplary embodiment.

In operation S610, the app is executed in the portable terminal 200. In operation S620, the portable terminal 200 collects context information. The collected context information may include the location of the portable terminal 200, the time when the app is executed, and the weather information (for example, temperature and humidity).

In operation S630, the portable terminal 200 determines whether sufficient amount of information about the currently executed app exists in the storage unit 210 of the portable terminal in order to store the information about the currently executed app. The information about the currently executed app may include the name, the type, featured functions, the generation time, and the latest update date of the app. The portable terminal 200 may determined whether the sufficient amount of information about the currently executed app exists in the storage unit 210 based on the name, the type, the featured functions, the generation time, and the latest update date of the app. For example, if at least one of the name, the type, the featured functions, the generation time, and the latest update date of the app does not exist, the portable terminal 200 may determine that a sufficient amount of information about the corresponding app does not exist. When the portable terminal 200 determines that a sufficient amount of information about the currently executed app exists in the storage unit 210, operation S640 is performed, and if not, operation S650 is performed.

In operation S650, the portable terminal 200 requests the server 100 for the information about the currently executed app. In operation S660, the portable terminal 200 receives the information related to the currently executed app from the server 100.

In operation S640, the portable terminal 200 stores the information about the currently executed app with the collected context information.

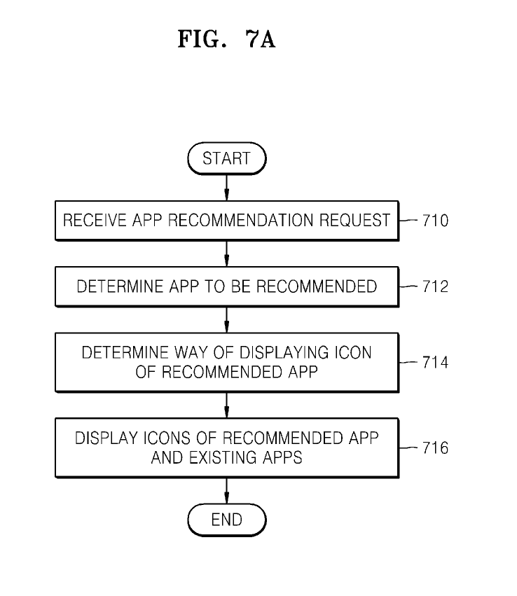

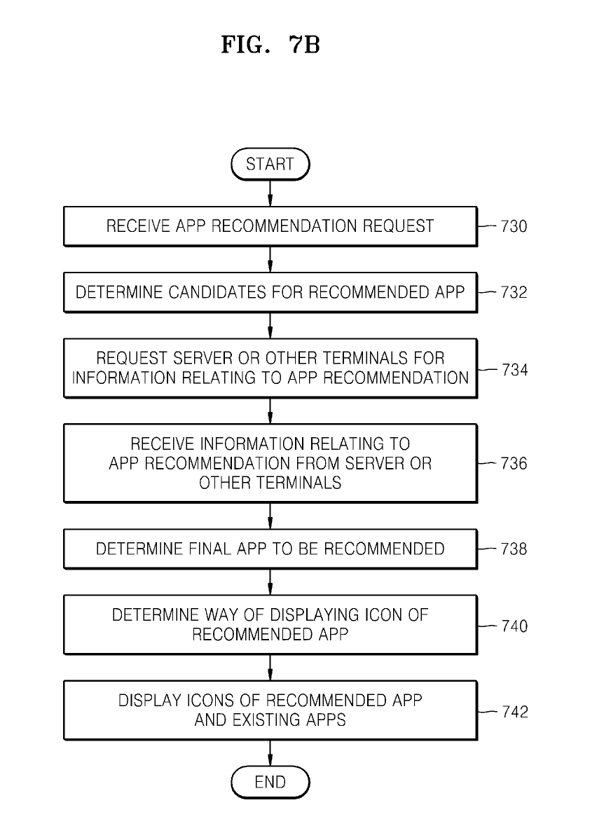

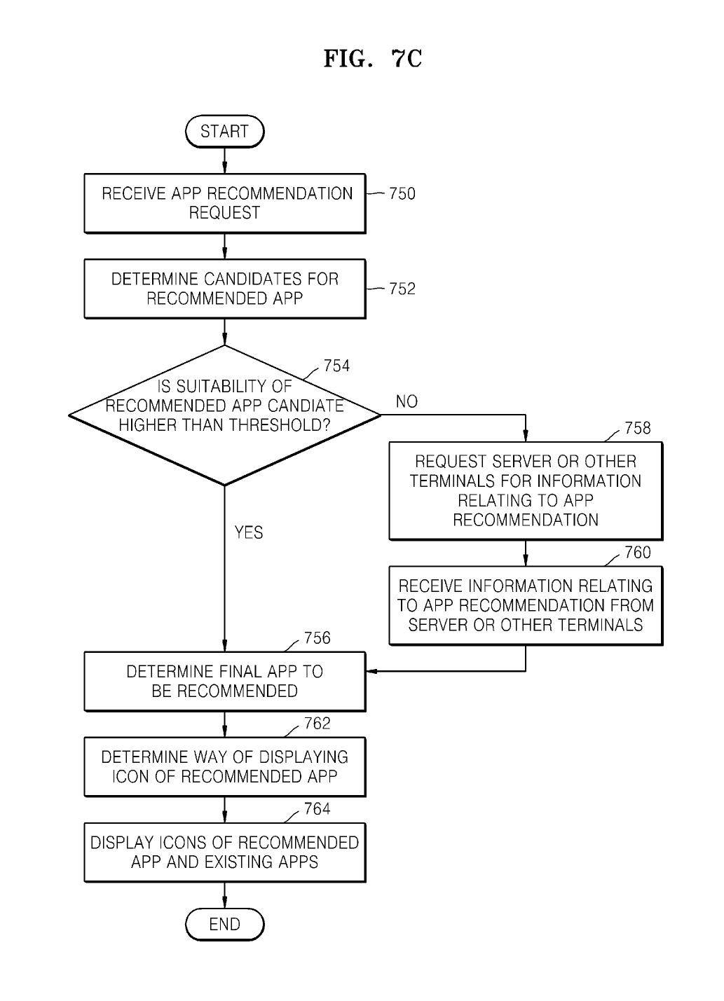

FIGS. 7A through 7C are flowcharts illustrating processes of determining and displaying a recommended app in the portable terminal 200 according to exemplary embodiments.

FIG. 7A illustrates processes of determining and displaying a recommended app, performed by the portable terminal 200 itself, without requesting the external device for the information about the app recommendation, that is, the server 100 or the other portable terminals 300 and 400 of FIG. 1.

In operation S710, the portable terminal 200 receives a request signal for the app recommendation. The request signal for the app recommendation may be input by the user of the portable terminal 200, or may be input from the server 100 or the other portable terminals 300 and 400 through the network 500 shown in FIG. 1. After receiving the request signal for the app recommendation, the portable terminal 200 determines the app to be recommended in operation S712. In some exemplary embodiments, the portable terminal 200 may perform operation S712 automatically at a certain time or may perform operation S712 automatically after a certain event occurs in the portable terminal 200, without receiving the request signal (S710).

In operation S712, the portable terminal 200 determines the app to be recommended based on the context information at the time when the app recommendation request is received and the information stored in the storage unit 210 of the portable terminal 200. In some exemplary embodiments, the portable terminal 200 may determine the app that is frequently used or used for a long time, or an app of the same type as the app that is frequently used or used for a long time as the recommended app, based on the context information (physical location, the time, and the weather information).

In operation S714, the portable terminal 200 determines a manner of displaying an icon of the app that is determined as the recommended app. The manner of displaying the icon of the app that is determined as the recommended app will be described in more detail with reference to FIGS. 8A through 8D.

In operation S716, the portable terminal 200 displays the icon of the recommended app and icons of the existing apps, based on the determined manner of displaying the icon of the recommended app.

FIG. 7B illustrates processes of determining candidates for a recommended app, performed by the portable terminal 200, and determining a final recommended app based on information related to the app recommendation received from the external device, that is, the server 100 or the other portable terminals 300 and 400.

In operation S730, the portable terminal 200 receives a request signal for app recommendation. Operation S730 is similar to the operation S710 shown in FIG. 7A.

In operation S732, the portable terminal 200 determines candidates for the recommended app based on the context information at the time when the app recommendation request is received and the information stored in the storage unit 210 of the portable terminal 200. Operation S732 is similar to the operation S712 shown in FIG. 7A.

In operation S734, the portable terminal 200 requests the server 100 or the other portable terminals 300 and 400 for the information related to the app recommendation.

In operation S736, the portable terminal 200 receives the information related to the app recommendation from the server 100 or the other portable terminals 300 and 400.

In operation S738, the portable terminal 200 determines a final app to be recommended from among the candidates for the recommended app, based on the received information and the candidates determined by the portable terminal 200 itself. In the exemplary embodiment, the portable terminal 200 itself may determine all of the candidates based on the received information related to the app recommendation in operation S736 and the candidates determined by the portable terminal 200 itself as the recommended apps. In another exemplary embodiment, the portable terminal 200 itself may determine the apps having a suitability that is equal to or greater than a predetermined threshold as the final apps to be recommended, from among the candidates determined based on the received information related to the app recommendation in operation S736 and the candidates determined by the portable terminal 200 itself. Here, the threshold of the suitability is a value representing a degree of suitability of a certain app to be recommended in corresponding context, based on the number of times of usage or the time of usage of the specific app in a certain context.

In operation S740, the portable terminal 200 determines a manner of displaying an icon of the app that is determined as the recommended app. The manner of displaying the icons of the recommended apps will be described in more detail with reference to FIGS. 8A through 8D.

In operation S742, the portable terminal 200 displays the icon of the recommended app and the icons of the existing apps based on the determined manner of displaying the icon of the recommended app.

FIG. 7C is a flowchart illustrating processes of determining and displaying a recommended app according to another exemplary embodiment. The processes shown in FIG. 7C are similar to those of FIG. 7B, except that the portable terminal 200 firstly determines the candidates for the recommended app, and requests the server or the other portable terminals for the information about the app recommendation only when the suitability of the candidates of the recommended app is less than the predetermined threshold.

FIGS. 8A through 8D are diagrams showing examples of displaying an icon of the recommended app and icons of the existing apps in the display setting unit 240 shown in FIG. 2, according to exemplary embodiments. In more detail, the display setting unit 240 displays the icon of the recommended app to be distinguished from the icons of the apps that are not recommended. As such, the user may easily identify locations of the icons of the existing apps, even when the recommended app is displayed on the display unit 250.

In more detail, in FIGS. 8A and 8B, the display setting unit 240 displays the icons in a previous arrangement before displaying the recommended app, and additionally displays the icon of the recommended app or an icon of a recommended folder matched with the recommended app. Here, the display setting unit 240 may set the icon of the recommended app to be displayed additionally while the icon of the recommended app still exists in the previous arrangement, or may set the icon of the recommended app to be displayed without being displayed in the previous arrangement.

In an exemplary embodiment, the display setting unit 240 may change a color of at least a part of the display unit 250, or distinguish the color of the icon of the recommended app and the icon of the recommended folder from the color of the icons of the existing apps. Thus, the user may easily identify the icon of the recommended app and the icon of the recommended folder. The change of color may include changes in brightness, clarity, and/or transparency.

According to another exemplary embodiment, the display setting unit 240 generates and displays at least one recommended folder icon, and may set the icon of the recommended app related to the recommended folder to be further displayed when the user selects the recommended folder icon. According to the present exemplary embodiment, the display setting unit 240 may display the recommended folder having a preset name. For example, when a recommended folder named as “weather” is set in advance and an app related to the recommended folder named as “weather” is determined as the recommended app, the display setting unit 240 displays the recommended folder named as “weather”. Then, when the user selects the recommended folder named as “weather”, the display setting unit 240 may further display the icon of the recommended app related to the weather from among the recommended apps.

According to another exemplary embodiment, the name of the recommended folder is determined by an input of the user, and the apps in the portable terminal 200 may be matched with the recommended folder according to the setting of the user. For example, the user determines the name of a recommended folder as “news”, and sets certain apps related to the news to be matched with the recommended folder named as “news”. In this case, when at least one from among the apps relates to the news, the display setting unit 240 displays the folder named as “news” first, and then, when the user selects the folder named as “news”, icons of the recommended apps related to the news may be further displayed.

According to the exemplary embodiment shown in FIG. 8B, the display setting unit 240 allocates a part of the display unit as a recommendation display area, and the recommendation display area may be used to display the icon of the recommended app or the icon of the recommended folder. According to the current exemplary embodiment, the display setting unit 240 partitions the display area of the display unit 250, and a certain partitioned area is set as the recommendation display area to display the icon of the recommended app or the icon of the recommended folder. In this case, the display setting unit 240 may display the icons of the apps included in the portable terminal 200 in the previous arrangement in any area except for the recommendation display area.

According to the exemplary embodiment of FIG. 8A, the display setting unit 240 may set the recommendation display area to be displayed as a pop-up window. In this case, in a state where the icons of the apps included in the portable terminal 200 are displayed, the pop-up window overlaps with the displayed icons. The icon of the recommended app or the icon of the recommended folder is displayed in the display area of the pop-up window. The pop-up window may be displayed while blocking the icons existing in the region where the pop-up window is displayed, or may be displayed as if the pop-up window is located on a higher layer of the icons located in the region where the pop-up window is displayed by changing the color of the icons located in the region where the pop-up window is displayed. The changing of the color may include changing the brightness, the clarity, and/or the transparency.

FIG. 8C shows an example in which a size of the icon of the recommended app is different from sizes of the icons of the existing apps. For example, in FIG. 8C, from among app1 through app9, app2, app4, and app5 are determined as the recommended apps, and icons of the app2, app4, and app5 are greater than the icons of the other apps.

FIG. 8D shows an example in which an icon of the recommended app is distinguished from the display unit 250 or the icons of the other apps by changing the color. For example, if app2, app4, and app5 are determined as recommended apps from among app1 through app9, color of some parts of the display unit 250 corresponding to peripheries of icons of the app2, app4, and app5 are changed to be distinguished from the icons of the other apps. Here, the changing of the color may include changing an RGB configuration in a certain pixel, and changing the brightness, the clarity, and/or the transparency.

According to another exemplary embodiment, icons of the recommended apps are repeatedly flickered or rotated while the icons of the existing apps do not, and thus the icons of the recommended apps may be distinguished from the icons of the existing apps.

According to exemplary embodiments, various applications suitable for a user of the portable terminal may be recommended by using context information of the user and the context information of other users.

In addition, according to exemplary embodiments, the user may easily and intuitively access the applications recommended for the user of the portable terminal to use the recommended applications.

The exemplary embodiments may be written as computer programs in a recording medium including commands executable by a computer such as a program module executed by the computer. The computer readable recording medium is any medium accessed by the computer, volatile and non-volatile media, and detachable and non-detachable media. In addition, the computer readable recording medium may include a computer storage medium and a communication medium. The computer storage medium may include the volatile and non-volatile media, and the detachable and non-detachable media realized by any method or technologies for storing information such as a computer readable command, data structures, program modules, and other data. The communication medium typically includes computer readable commands, the data structures, the program module, or other data such as a modulated data signal, or other transmission mechanisms, and includes any information transfer medium.

While exemplary embodiments have been particularly shown and described, it will be understood by those of ordinary skill in the art that various changes in form and details may be made therein without departing from the spirit and scope of the exemplary embodiments as defined by the following claims.

1. An apparatus for recommending applications based on context information, the apparatus comprising:
a context information collecting unit which collects context information;
a recommended application determination unit which determines at least one recommended application from among applications based on the collected context information;
a display setting unit which sets an icon of the at least one recommended application to be displayed based on the determination of the recommended application determination unit; and
a display unit which displays the icon of the at least one recommended application based on settings of the display setting unit.

2. The apparatus of claim 1, wherein the context information relates to a user, and the applications are included in the apparatus.

3. The apparatus of claim 1, wherein the context information comprises at least one from among location information and time information of the apparatus.

4. The apparatus of claim 3, wherein the recommended application determination unit determines the at least one recommended application from among applications executed more frequently than a predetermined frequency and applications executed longer than a predetermined time period, in the applications of the apparatus.

5. The apparatus of claim 3, wherein the recommended application determination unit determines at least one from among an application having a type corresponding to applications executed more frequently than a predetermined frequency and an application having a type corresponding to applications executed longer than a predetermined time period, in the applications of the apparatus.

6. The apparatus of claim 1, wherein the context information collecting unit comprises a receipt unit for receiving information related to an application recommendation from a server or at least one other apparatus, and the recommended application determination unit determines the recommended application based on the collected context information and the received information related to the application recommendation.

7. The apparatus of claim 6, wherein the received information related to the application recommendation comprises at least one from among names, types, and featured functions of applications that are used in the at least one other apparatus.

8. The apparatus of claim 7, wherein the recommended application determination unit determines at least one from among an application that is the same as the application included in the information related to the application recommendation and an application having a type corresponding to the application included in the information related to the application recommendation, from among the applications in the apparatus.

9. The apparatus of claim 6, wherein the at least one other apparatus is located within a predetermined distance from the apparatus.

10. The apparatus of claim 1, wherein the display setting unit performs display setting so that icons of the applications included in the apparatus are displayed as in a previous arrangement, and at least one icon of a recommended folder matches with the at least one recommended application or an icon of the at least one recommended application.

11. The apparatus of claim 10, wherein the display setting unit designates a part of the display unit as a recommendation display area, and displays the at least one icon of the recommended folder and the recommended application in the recommendation display area.

12. The apparatus of claim 11, wherein the display setting unit sets the recommendation display area to be displayed in a partitioned region that is set in the display unit in advance.

13. The apparatus of claim 11, wherein the display setting unit sets the recommendation display area to be displayed as a pop-up window on the display unit.

14. The apparatus of claim 10, wherein the display setting unit sets an icon of the at least one recommended application matching with the recommended folder icon to be further displayed when the recommended folder icon is selected by an input of a user.

15. The apparatus of claim 1, wherein the display setting unit sets the icon of the at least one recommended application to have a different size from icons of other applications in the apparatus.

16. The apparatus of claim 1, wherein the display setting unit sets the icon of the recommended application to repeatedly flicker or rotate.

17. The apparatus of claim 1, wherein the display setting unit sets a color of the icon of the at least one recommended application to be distinguished from a color of an icon of an application that is not recommended, by changing a color of at least a part of the display unit, or changing a color of at least one from among icons of the applications in the apparatus and the icon of the at least one recommended application.

18. A server which provides an apparatus with information related to application recommendation, the server comprising:
a receipt unit which receives information about applications used in other apparatuses, from the other apparatuses;
a recommended information determination unit which determines the information related to the application recommendation, which is to be transmitted to the apparatus, based on the received information; and
a transfer unit which transmits the information related to the application recommendation determined by the recommended information determination unit,
wherein the information related to the application recommendation is used to determine an application to be recommended from among applications.

19. The server of claim 18, wherein the applications are provided in the apparatus.

20. The server of claim 18, wherein the received information comprises information about at least one of names, types, featured functions, usage frequencies, and usage times of the applications used in the other apparatuses.

21. The server of claim 20, wherein the recommended information determination unit determines at least one from among applications used in a predetermined number or more apparatuses, applications that are used more frequently than a predetermined frequency, and applications that are used longer than a predetermined time period, as a recommended application, and wherein the information related to the application recommendation comprises information related to at least one from among a name, a type, and featured functions of the recommended application.

22. The server of claim 18, wherein the other apparatuses are located within a predetermined distance from the apparatus.

23. A method of recommending and displaying an application in an apparatus, the method comprising:
collecting context information;
determining at least one recommended application from among applications included in the apparatus based on the collected context information; and
displaying the at least one recommended application based on the determination.

24. The method of claim 23, wherein the context information is related to a user.

25. The method of claim 23, wherein the context information comprises at least one from among location information and time information of the apparatus.

26. The method of claim 25, wherein the determining of the at least one recommended application comprises determining at least one application from among applications executed more frequently than a predetermined frequency and applications executed longer than a predetermined time period, in the applications of the apparatus.

27. The method of claim 25, wherein the determining of the at least one recommended application comprises determining at least one from among an application having a type corresponding to applications executed more frequently than a predetermined frequency and an application having a type corresponding to applications executed longer than a predetermined time period.

28. The method of claim 23, wherein the collecting of the context information comprises receiving information related to an application recommendation from a server or at least one other apparatus, and the determining of the at least one recommended application comprises determining the at least one recommended application based on the collected context information and the received information related to the application recommendation.

29. The method of claim 28, wherein the received information related to the application recommendation comprises at least one from among names, types, and featured functions of applications that are used in the at least one other apparatus.

30. The method of claim 29, wherein the determining of the at least one recommended application comprises determining at least one from among an application that is the same as the application included in the information related to the application recommendation and an application having a type corresponding to the application included in the information related to the application recommendation, from among the applications in the apparatus.

31. The method of claim 28, wherein the at least one other apparatus is located within a predetermined distance from the apparatus.

32. The method of claim 23, wherein the displaying of the at least one recommended application comprises displaying icons of the applications included in the apparatus in a previous arrangement, and wherein at least one icon of a recommended folder matches with the at least one recommended application or an icon of the at least one recommended application.

33. The method of claim 32, wherein the displaying of the at least one recommended application comprises designating a part of the display unit as a recommendation display area, and displaying the at least one icon of the recommended folder and the recommended application in the at least one recommendation display area.

34. The method of claim 33, wherein the displaying of the at least one recommended application comprises displaying the recommendation display area in a partitioned region that is set in the display unit of the apparatus in advance.

35. The method of claim 33, wherein the displaying of the recommended application comprises displaying the recommendation display area as a pop-up in the display unit of the apparatus.

36. The method of claim 32, wherein the displaying of the recommended application further comprises displaying an icon of at least one recommended application matching with the recommended folder icon when the recommended folder icon is selected by an input of the user.

37. The method of claim 23, wherein the displaying of the at least one recommended application comprises displaying an icon of the at least one recommended application to have a different size from icons of other applications in the apparatus.

38. The method of claim 23, wherein the displaying of the at least one recommended application comprises displaying an icon of the at least one recommended application to repeatedly flicker or rotate.

39. The method of claim 23, wherein the displaying of the at least one recommended application distinguishes a color of an icon of the at least one recommended application from a color of an icon of an application that is not recommended, by changing a color of at least a part of the display unit of the apparatus, or changing a color of at least one of the icons of the applications in the apparatus and the icon of the at least one recommended application.

40. A method of providing an apparatus with information related to an application recommendation from a server, the method comprising:
receiving information about applications used in other apparatuses from the other apparatuses;
determining information related to the application recommendation, which is to be transferred to the apparatus; and
transferring, by the server, the determined information related to the application recommendation to the apparatus from the server,
wherein the transferred information related to the application recommendation is used to determine an application to be recommended from among applications.

41. The method of claim 40, wherein the receiving and the determining are performed by the server.

42. The method of claim 40, wherein the received information comprises information related to at least one from among names, type, featured functions, usage frequencies, and usage times of applications that are used in the other apparatuses.

43. The method of claim 42, wherein the determining of the information related to the application recommendation comprises determining at least one from among applications used in a predetermined number or more apparatuses, applications that are used more frequently than a predetermined frequency, and applications that are used longer than a predetermined time period as a recommended application, and the information related to the application recommendation comprises information related to at least one from among a name, a type, and featured functions of the recommended application.

44. The method of claim 40, wherein the other apparatuses are located within a predetermined distance from the apparatus.

45. A computer readable recording medium having embodied thereon a program for executing a method of recommending and displaying an application in an apparatus, wherein the method comprises:
collecting context information of a user;
determining at least one recommended application from among applications included in the apparatus based on the collected context information; and
displaying the at least one recommended application based on the determination.

46. A computer readable recording medium having embodied thereon a program for executing a method of providing an apparatus with information related to an application recommendation from a server, wherein the method comprises:
receiving information about applications used in other apparatuses from the other apparatuses;
determining information related to the application recommendation, which is to be transferred to the apparatus; and
transferring, by the server, the determined information related to the application recommendation to the apparatus from the server,
wherein the transferred information related to the application recommendation is used to determine an application to be recommended from among the applications.
